(19) United States
(12) Patent Application Publication
(10) Pub. No.: US 2025/0140250 A1
(43) Pub. Date: May 1, 2025

(54) VOICE RECOGNITION APPARATUS

(71) Applicant: TOYOTA JIDOSHA KABUSHIKI KAISHA, Toyota-shi (JP)

(72) Inventors: Yu NAGATA, Tokyo-to (JP); Ryota YANAGISAWA, Tokyo-to (JP); Akira MIYAMOTO, Nisshin-shi (JP); Eiichi MAEDA, Asaka-shi (JP); Haruto TOYAMA, Nagoya-shi (JP); Kotaro HIROSE, Nisshin-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/906,455

(22) Filed: Oct. 4, 2024

(30) Foreign Application Priority Data
Oct. 30, 2023 (JP) 2023-185789

(51) Int. Cl. G10L 15/22; B60R 16/037; G10L 15/30

(52) U.S. Cl. CPC G10L 15/22; B60R 16/0373; G10L 15/30; G10L 2015/228

(57) ABSTRACT

A voice recognition apparatus includes a controller configured to recognize voice input from an occupant of a vehicle, and control a function according to the recognized voice input, the controller outputting notification that differs between a case in which the controller has not been able to recognize the voice input and a case in which the controller has recognized the voice input and the function is not available.

### CROSS-REFERENCE TO RELATED APPLICATION

This application claims priority to Japanese Patent Application No. 2023-185789, filed on Oct. 30, 2023, the entire contents of which are incorporated herein by reference.

### TECHNICAL FIELD

The present disclosure relates to a voice recognition apparatus.

### BACKGROUND

Patent Literature (PTL) 1 discloses an apparatus that includes a voice recognition unit. The voice recognition unit determines whether the voice information for an occupant acquired by an in-vehicle microphone includes predetermined voice information. When the predetermined voice information is included, the ignition is activated. When the predetermined voice information is not included, the ignition is not activated.

### CITATION LIST

### Patent Literature

PTL 1: JP 2021-107192 A

### SUMMARY

In a conventional apparatus, when voice input from a user has not been accepted, the user does not know whether it was impossible to recognize the voice input in the first place or whether the function according to the voice input is not available.

It would be helpful to make it easier for a user to know, when voice input from the user has not been accepted, whether it was impossible to recognize the voice input in the first place or whether the function according to the voice input is not available.

A voice recognition apparatus according to the present disclosure includes a controller configured to:
recognize voice input from an occupant of a vehicle; and
control a function according to the recognized voice input, the controller outputting notification that differs between a case in which the controller has not been able to recognize the voice input and a case in which the controller has recognized the voice input and the function is not available.

According to the present disclosure, it is easier for a user to know, when voice input from the user has not been accepted, whether it was impossible to recognize the voice input in the first place or whether the function according to the voice input is not available.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a voice recognition apparatus according to the embodiment of the present disclosure;

FIG. 3 is a table illustrating an example of definition data according to the embodiment of the present disclosure;

FIG. 4 is a flowchart illustrating operations of the voice recognition apparatus according to the embodiment of the present disclosure; and

FIG. 5 is a table illustrating an example of data stored in a database of a server apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

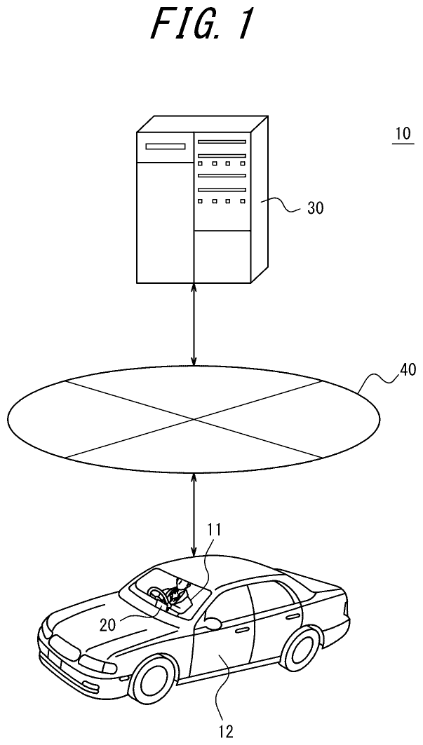

A configuration of a system 10 according to the present embodiment will be described with reference to FIG. 1.

The system 10 according to the present embodiment includes a voice recognition apparatus 20 and a server apparatus 30. The voice recognition apparatus 20 can communicate with the server apparatus 30 via a network 40.

The voice recognition apparatus 20 is a computer having a voice recognition function mounted in a vehicle 12. The voice recognition apparatus 20 is used by a user 11. The user 11 is an occupant of the vehicle 12.

The server apparatus 30 is a computer that belongs to a cloud computing system or other computing system installed in a facility such as a data center. The server apparatus 30 is operated by a service provider, such as a web service provider.

The vehicle 12 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12 may be driven by the user 11, or the driving may be automated at any level. The automation level is, for example, any one of Level 1 to Level 5 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The voice recognition apparatus 20 recognizes voice input from the user 11 and controls a function according to the recognized voice input. However, in a case in which the voice recognition apparatus 20 has not been able to recognize the voice input, it does not control any function and outputs a third notification. In a case in which the voice recognition apparatus 20 has recognized the voice input but the function according to the recognized voice input is not available, it does not control the function and outputs a second notification that is different from the third notification. In other words, the voice recognition apparatus 20 outputs notification that differs between a case in which the voice recognition apparatus 20 has not been able to recognize the voice input and a case in which the voice recognition apparatus 20 has recognized the voice input and the function is not available.

According to the present embodiment, it is easier for the user 11 to know, when voice input from the user 11 has not been accepted, whether it was impossible to recognize the voice input in the first place or whether the function according to the voice input is not available.

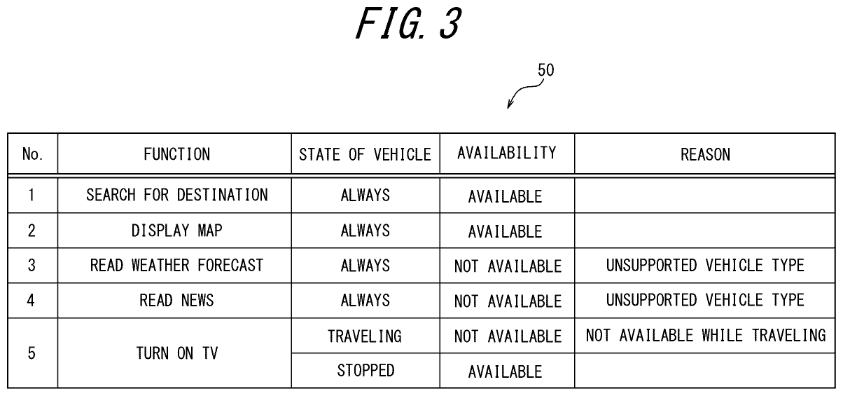

In the present embodiment, the voice recognition apparatus 20, upon recognizing the voice input from the user 11, determines the availability of the function according to the voice input with reference to definition data 50 defining a plurality of functions and the availability of each function, as illustrated in FIG. 3. As illustrated in FIG. 3, the definition data 50 may be data defining the availability of each function according to the state of the vehicle 12. As illustrated in FIG. 3, the definition data 50 may further include data defining reasons for being not available with respect to one or more unavailable functions among the plurality of functions. The voice recognition apparatus 20 may include an explanation of a reason defined with respect to the function according to the voice input by the definition data 50 in the second notification in the case in which the voice recognition apparatus 20 has recognized the voice input and the function according to the voice input is not available. The voice recognition apparatus 20 may transmit data identifying the vehicle type of the vehicle 12 and data indicating the function according to the voice input to the server apparatus 30 in the case in which the voice recognition apparatus 20 has recognized the voice input and the function according to the voice input is not available. The definition data 50 may be different for each vehicle type, and furthermore, may be different for each year or grade. The definition data 50 is stored in the voice recognition apparatus 20 in the present embodiment, but may be stored in the server apparatus 30 or an external storage device.

In the example illustrated in FIG. 3, the definition data 50 is configured as a table containing four columns: Function, State of Vehicle 12, Availability, and Reason. The Function column defines the controllable and non-controllable functions depending on the voice input recognized by the voice recognition apparatus 20 mounted in the vehicle 12. For example, the Function column includes No. 1, “Search for destination”, to No. 5, “Turn on TV”, as functions according to voice input. The State of Vehicle 12 column defines the states of the vehicle 12. The Availability column defines the availability of each function according to the state of the vehicle 12. The Reason column defines the reason why the function defined in the corresponding field of the Function column is not available when the corresponding field of the Availability column is “Not available”. For example, for No. 1 of the definition data 50, “Search for destination”, the state of the vehicle 12 is defined as “Always” and the availability is defined as “Available”. Therefore, when the voice recognition apparatus 20 recognizes the voice input “I want to go to X” from the user 11, it always controls the function “Search for destination” regardless of the state of the vehicle 12. In this case, the controller 21 causes the navigation system mounted in the vehicle 12 to search for a place called X and set the searched X as the destination. For example, for No. 3 in the definition data 50, “Read weather forecast”, the state of the vehicle 12 is defined as “Always”, the availability is defined as “Not available”, and the reason is defined as “unsupported vehicle type”. Therefore, the voice recognition apparatus 20 does not control the function “Read weather forecast” even if it recognizes the voice input “Tell me the weather forecast” from the user 11. For example, for No. 5 “Turn on TV” in the definition data 50, the state of the vehicle 12 is defined as “Traveling” and “Stopped”, the availability is “Not available” when the vehicle is “Traveling”, the reason is “not available while traveling”, and the availability is “Available” when the vehicle is “Stopped”. Therefore, when the voice recognition apparatus 20 recognizes the voice input “Turn on TV” from the user 11, it does not control the “Turn on TV” function if the vehicle 12 is traveling, but controls the “Turn on TV” function if the vehicle 12 is stopped. In the latter case, the controller 21 displays the TV program on the multimedia screen of the display mounted in the vehicle 12.

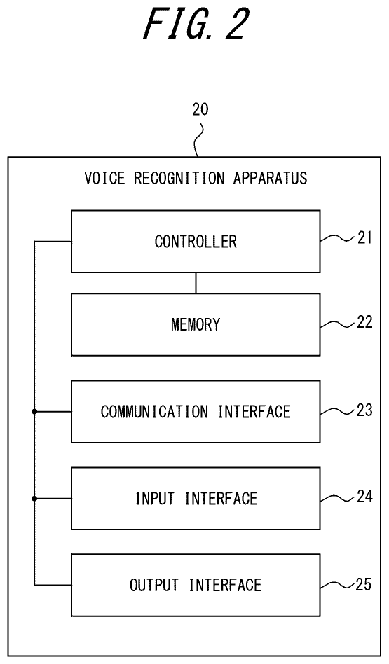

A configuration of the voice recognition apparatus 20 according to the present embodiment will be described with reference to FIG. 2.

The voice recognition apparatus 20 includes a controller 21, a memory 22, a communication interface 23, an input interface 24, and an output interface 25.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to the operations of the voice recognition apparatus 20 while controlling the components of the voice recognition apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores data to be used for the operations of the voice recognition apparatus 20 and data obtained by the operations of the voice recognition apparatus 20.

The communication interface 23 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The name “IEEE” is an abbreviation of Institute of Electrical and Electronics Engineers. The communication interface 23 communicates with the server apparatus 30. The communication interface 23 receives data to be used for the operations of the voice recognition apparatus 20, and transmits data obtained by the operations of the voice recognition apparatus 20.

The input interface 24 includes at least one input device. The input device is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 24 accepts operations for inputting data to be used for the operations of the voice recognition apparatus 20. The input interface 24, instead of being included in the voice recognition apparatus 20, may be connected to the voice recognition apparatus 20 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one output device. The output device is, for example, a display or a speaker. The display is, for example, an LCD or an organic EL display. The term “LCD” is an abbreviation of liquid crystal display. The term “EL” is an abbreviation of electro luminescent. The output interface 25 outputs data obtained by the operations of the voice recognition apparatus 20. The output interface 25, instead of being included in the voice recognition apparatus 20, may be connected to the voice recognition apparatus 20 as an external output device such as a display audio. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The functions of the voice recognition apparatus 20 are realized by execution of a program according to the present embodiment by a processor serving as the controller 21. That is, the functions of the voice recognition apparatus 20 are realized by software. The program causes a computer to execute the operations of the voice recognition apparatus 20, thereby causing the computer to function as the voice recognition apparatus 20. That is, the computer executes the operations of the voice recognition apparatus 20 in accordance with the program to thereby function as the voice recognition apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the voice recognition apparatus 20 may be realized by a programmable circuit or a dedicated circuit serving as the controller 21. That is, some or all of the functions of the voice recognition apparatus 20 may be realized by hardware.

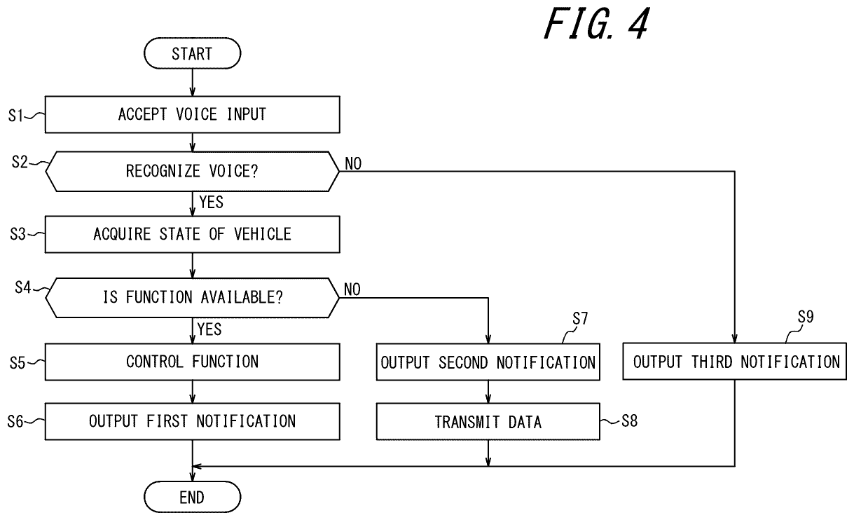

Operations of the voice recognition apparatus 20 according to the present embodiment will be described with reference to FIG. 4. The operations described below correspond to a control method according to the present embodiment. In other words, the control method according to the present embodiment includes steps S1 through S9 illustrated in FIG. 4.

Step S1 is initiated when the user 11 issues a startup command such as “Hey, car!” or by pressing a startup button on the screen display or a physically placed startup button.

In S1, the controller 21 accepts voice input from the user 11. For example, the controller 21 accepts voice input from the user 11, such as “I want to go to X” or “Turn on the TV” via the microphone as the input interface 24.

In S2, the controller 21 determines whether the voice input from the user 11 was recognized or not. If it is recognized (S2—YES), the process proceeds to S3. If not recognized (S2—NO), the process proceeds to S9. For example, if the voice input “I want to go to X” is recognized in S2, the process proceeds to S3. If, for example, the “I want to go” part was recognized in S2, but the location was not heard, the process proceeds to S9.

In S3, the controller 21 acquires the state of the vehicle 12. For example, the controller 21 acquires the state of the vehicle 12 by receiving data on the speed of the vehicle 12 via the communication interface 23 from a speedometer mounted in the vehicle 12.

In S4, the controller 21 determines whether the function is available according to the voice input recognized in S2 with reference to the definition data 50 as illustrated in FIG. 3. If available (S4—YES), the process proceeds to S5. If not available (S4—NO), the process proceeds to S7. For example, if the voice input “I want to go to X” can be recognized in S2, the controller 21 determines that the function “Search for destination” is available regardless of the state of the vehicle 12 acquired in S3, and the process proceeds to S5. On the other hand, if the voice input “Turn on TV” is recognized in S2 and the state of the vehicle 12 acquired in S3 is “Traveling”, the controller 21 determines that the function “Turn on TV” is not available and the process proceeds to S7.

In S5, the controller 21 controls the function determined to be available in S4 based on the voice input recognized in S2. For example, based on the voice input “I want to go to X” recognized in S2, the controller 21 controls the function “Search for destination” determined to be available in S4, and causes the navigation system mounted in the vehicle 12 to search for X. The controller 21 then causes the navigation system to set the searched X as the destination. After S5, the process proceeds to S6.

In S6, the controller 21 outputs a first notification. For example, when the controller 21 has the navigation system set X as the destination in S5, it outputs a voice saying “X is set as the destination” through the speaker as the output interface 25 as the first notification. For example, the controller 21 may display the message “X is set as the destination” on the display as the output interface 25 as the first notification.

After S6, the flow illustrated in FIG. 4 ends.

In S7, the controller 21 outputs a second notification. For example, the controller 21 notifies the user 11 of the reason for being not available defined in the definition data 50 with respect to the “Turn on TV” function, which was determined to be not available in S4 based on the voice input “Turn on TV” recognized in S2. Specifically, the controller 21 outputs a voice message “Not available while traveling” as the second notification via a speaker as the output interface 25. For example, the controller 21 may display the message “Not available while traveling” on the display as the output interface 25 as the second notification. This allows the user 11 to know that the voice input was recognized, but that the functions according to the voice input are not available. After S7, the process proceeds to S8.

In S8, the controller 21 transmits data identifying the vehicle type of the vehicle 12 and data indicating the function determined to be not available in S4 to the server apparatus 30 via the communication interface 23. For example, the controller 21 transmits data indicating the vehicle type “AAA” of the vehicle 12 and the function “Turn on TV” to the server apparatus 30 via the communication interface 23. In addition, the controller 21 may also transmit data indicating the date of the voice input, a user ID identifying the user 11 or the reason for being not available. The term “ID” is an abbreviation of identifier.

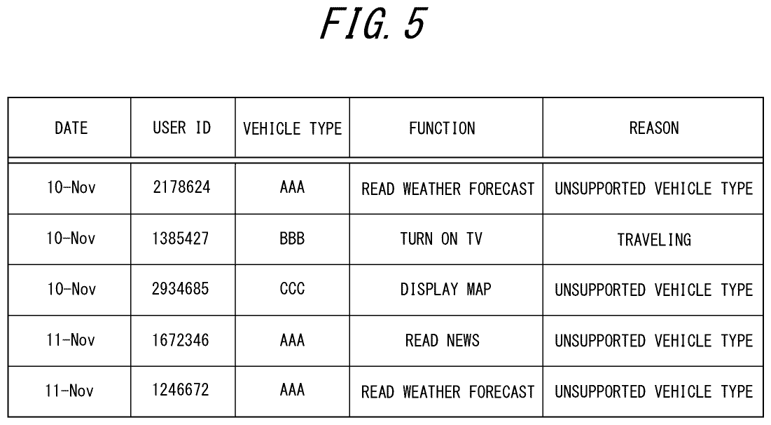

An example of the data stored in the database of the server apparatus 30 is shown in FIG. 5. In this example, data transmitted from the controller 21 indicating the date of voice input, a user ID, a vehicle type, a function, and a reason for being not available is stored in the database of the server apparatus 30. By storing the data transmitted from the controller 21 in the server apparatus 30, the operator can obtain information, for example, “the number of times users of the vehicle type AAA requested the function of reading weather forecasts. This allows operators to learn about functions that have been voice input but are not available, i.e., functions that are in demand by the user 11 but have not yet been implemented, and provides important marketing material for product development.

After S8, the flow illustrated in FIG. 4 ends.

In S9, the controller 21 outputs a third notification. For example, the controller 21 outputs a voice as the third notification, “Unrecognized. Please try again”, via a speaker as the output interface 25. This allows the user 11 to know that the voice input was not recognized.

After S9, the flow illustrated in FIG. 4 ends.

As described above, when the controller 21 recognizes voice input from the user 11, it controls a function according to the recognized voice input. The controller 21 outputs notification that differs between a case in which the controller has not been able to recognize the voice input and a case in which the controller has recognized the voice input and the function is not available.

According to the present embodiment, it is easier for the user 11 to know, when voice input from the user 11 has not been accepted, whether it was impossible to recognize the voice input in the first place or whether the function according to the voice input is not available.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A voice recognition apparatus comprising a controller configured to:
recognize voice input from an occupant of a vehicle; and
control a function according to the recognized voice input,
the controller outputting notification that differs between a case in which the controller has not been able to recognize the voice input and a case in which the controller has recognized the voice input and the function is not available.

2. The voice recognition apparatus according to claim 1, further comprising a communication interface configured to communicate with a server apparatus,
wherein the controller is configured to transmit data identifying a vehicle type of the vehicle and data indicating the function to the server apparatus via the communication interface in the case in which the controller has recognized the voice input and the function is not available.

3. The voice recognition apparatus according to claim 1, wherein the controller is configured to, upon recognizing the voice input, determine availability of the function with reference to definition data defining a plurality of functions and availability of each function.

4. The voice recognition apparatus according to claim 3, wherein
the definition data further includes data defining reasons for being not available with respect to one or more unavailable functions among the plurality of functions, and
the controller is configured to include an explanation of a reason defined with respect to the function by the definition data in the notification in the case in which the controller has recognized the voice input and the function is not available.

5. The voice recognition apparatus according to claim 3, wherein the definition data is data defining availability of each function according to a state of the vehicle.
